(19) United States
(12) Patent Application Publication
(10) Pub. No.: US 2011/0244590 A1
(43) Pub. Date: Oct. 6, 2011

(54) ANALYSIS APPARATUS AND METHOD

(75) Inventors: Mitsuaki UCHIDA, Kanagawa-ken (JP); Tomonori Nishio, Kanagawa-ken (JP); Tomonari Sendai, Kanagawa-ken (JP); Yuzuru Otsuka, Kanagawa-ken (JP); Katsuya Inana, Kanagawa-ken (JP)

(73) Assignee: FUJIFILM CORPORATION, Tokyo (JP)

(21) Appl. No.: 13/018,016

(22) Filed: Jan. 31, 2011

(30) Foreign Application Priority Data
Mar. 31, 2010 (JP) 080683/2010

(51) Int. Cl. G01N 21/75

(52) U.S. Cl. 436/164; 422/425

(57) ABSTRACT

A coloration state of a test region is read out as image density values by a readout device. A calculation is made to find a similarity degree between template information for the test region, which template information represents a state of coloration of the test region, and which has been stored previously in a pattern storing device, and the coloration state of the test region, which coloration state has been read out by the readout device. An analysis of an analyte is performed by a judgment device in accordance with the similarity degree, which has been calculated.

### BACKGROUND OF THE INVENTION

1. Field of the Invention

This invention relates to an analysis apparatus and an analysis method for performing a quantitative analysis or a qualitative analysis of an analyte (i.e., a substance to be analyzed), which is contained in a test body.

2. Description of the Related Art

Recently, for examinations of external diagnostic medicines, poisons, and the like, there have been proposed various devices for feeding test body solutions, which have the possibility of containing analytes, to test pieces, and easily and quickly making examinations with respect to the analytes by use of immunochromatographic techniques. Specifically, a development layer constituted of a porous material is prepared. The development layer is provided with a specific region (a test line), to which a first antibody that specifically binds with an analyte (e.g., an antigen) has been fixed. Also, a test body solution, which contains a mixture of a labeling second antibody that specifically binds with the analyte, and a test body having the possibility of containing the analyte, is developed through the development layer. As a result, an antigen-antibody reaction among the analyte, the first antibody, and the second antibody arises in the test line, and the test line is thus colored or develops color and comes into a coloration state. By observing the coloration state of the test line, it is quantitatively or qualitatively (negative/positive) analyzed whether the analyte is or is not present in the test body.

Also, in order for the coloration state of the test line to be detected quickly and with a high sensitivity, it has been proposed to perform amplification processing by use of an amplifying agent. (Reference may be made to, for example, U.S. Patent Application Publication No. 20090181470.) In U.S. Patent Application Publication No. 20090181470, it is disclosed that, with processing wherein, after the aforesaid test body solution has been developed through the development layer, the test line and a control line are washed by use of a washing liquid, and wherein an amplifying agent containing a metal ion, such as a silver ion, is developed through the development layer, the metal ion is bound with the complex of first antibody-analyte (antigen)-second antibody on the test line and thus amplifies the coloration state. Particularly, it is proposed to enhance the washing effect by inclining the direction of development of the washing liquid by a predetermined angle with respect to the direction of development of the analyte.

Further, in U.S. Patent Application Publication No. 20090181470, there is disclosed the case wherein a test region is formed in a strip-like shape on a test piece. Also, as for the shape of the test region (reaction region), in U.S. Pat. No. 5,552,276, it is disclosed that the test region (reaction region) is formed in a predetermined single pattern, such as a circle, a double circle, or a star-like shape.

However, the coloration appearing on the test region does not become uniform within the region, and non-uniformity in image density arises. Particularly, in cases where the washing with the washing liquid is performed as described in U.S. Patent Application Publication No. 20090181470, the problems are induced in that non-uniformity, or the like, occurs due to variation in washing effect at different positions within the region or due to flow of the washing liquid, and in that the detection accuracy becomes bad. Also, in cases where the test region is constituted of the specific pattern, such as the circle, as described in U.S. Pat. No. 5,552,276, the problems occur in that it is not always possible to confirm the coloration state.

### SUMMARY OF THE INVENTION

The primary object of the present invention is to provide an analysis apparatus, which accurately performs an analysis of an analyte.

Another object of the present invention is to provide an analysis method, which accurately performs an analysis of an analyte.

The present invention provides an analysis apparatus for performing an analysis of an analyte by use of a test piece provided with a development layer, through which a test body solution is developed, and a test region, which is formed on the development layer, and which has a predetermined shape, the test region reacting with an analyte contained in the test body solution and undergoing coloration as a result of the reaction, the apparatus comprising:

i) readout means for reading out the coloration state of the test region as image density values,

ii) pattern storing means for storing template information for the test region, which template information represents a state of coloration of the test region,

iii) similarity degree calculating means for calculating a similarity degree between the template information for the test region, which template information has been stored in the pattern storing means, and the coloration state of the test region, which coloration state has been read out by the readout means, and

iv) judgment means for performing the analysis of the analyte in accordance with the similarity degree, which has been calculated by the similarity degree calculating means.

The present invention also provides an analysis method for performing an analysis of an analyte by use of a test piece provided with a development layer, through which a test body solution is developed, and a test region, which is formed on the development layer, and which has a predetermined shape, the test region reacting with an analyte contained in the test body solution and undergoing coloration as a result of the reaction, the method comprising the steps of:

i) reading out the coloration state of the test region as image density values by readout means,

ii) calculating a similarity degree between template information for the test region, which template information represents a state of coloration of the test region, and which has been stored previously in pattern storing means, and the coloration state of the test region, which coloration state has been read out by the readout means, and

iii) performing the analysis of the analyte in accordance with the similarity degree, which has been calculated.

It is sufficient for the test region to come into the coloration state due to the presence of the analyte in the test body solution. For example, the test region may be of the type utilizing a chromatographic technique, particularly an immunochromatographic technique, in which immunoassay utilizing an antigen-antibody reaction is applied to the chromatographic technique. Also, each of the shape of the test region and the shape of a control region is not limited particularly. For example, each of the test region and the control region may be formed in a line-like shape. Alternatively, each of the test region and the control region may have a predetermined pattern.

Also, the coloration state may be such that the test region forms color or discolors due to the presence of the analyte, or such that the control region forms color or discolors due to the test body solution. Further, the image density values may be the values representing the intensities of the formed color of the coloration state or the degrees of discoloring of the coloration state. Furthermore, the readout means may be selected from various constitutions, with which the coloration state of the test region is read out as the image density values. For example, the readout means may acquire an image of the test piece by use of an image pickup device. Alternatively, the readout means may be constituted such that light is irradiated to the test piece, and such that the light reflected from the test piece is received by a light receiving element. Also, the readout means may read out the changes in density of the coloration state as the image density values. Alternatively, the readout means may read out the intensities of the light (fluorescence) having a predetermined wavelength as the image density values.

The analysis apparatus in accordance with the present invention may be modified such that the similarity degree calculating means calculates a correlation value, which is obtained by performing convolution on the template information for the test region and the image density values of the test region, which image density values have been read out by the readout means, and

the thus calculated correlation value is taken as the similarity degree.

Also, the analysis apparatus in accordance with the present invention may be modified such that the judgment means stores information representing a set threshold value, which has been set previously, and performs a quantitative or qualitative judgment of the analyte by comparing the similarity degree and the set threshold value with each other.

Further, the analysis apparatus in accordance with the present invention may be modified such that the test region is constituted of a predetermined pattern comprising a plurality of basic pattern sections, each of which is constituted of a basic pattern, the template information for the test region represents the state of coloration of the basic pattern constituting each of the basic pattern sections,

the similarity degree calculating means calculates a correlation value between the template information for the test region and the coloration state of the basic pattern, which coloration state has been read out by the readout means, the calculation of the correlation value being made with respect to each of the basic pattern sections, and

the similarity degree calculating means calculates the similarity degree in accordance with the result of the calculation of the correlation value between the template information for the test region and the coloration state of the basic pattern, which coloration state has been read out by the readout means.

Furthermore, the analysis apparatus in accordance with the present invention may be modified such that the basic pattern comprises a polygon or a circle, and

the test region is constituted of the predetermined pattern comprising the plurality of the basic pattern sections, each of which is constituted of the basic pattern, the plurality of the basic pattern sections being arrayed so as to stand side by side in a direction perpendicularly intersecting with the direction of the development of the test body solution.

Also, the analysis apparatus in accordance with the present invention may be modified such that the test piece is further provided with a control region, which is formed on a downstream side of the test region with respect to the direction of the development of the test body solution, and which has a predetermined shape, the control region undergoing coloration as a result of passage of the test body solution through the control region,

the readout means also reads out the coloration state of the control region as the image density values,

the pattern storing means also stores template information for the control region, which template information represents a state of coloration of the control region,

the similarity degree calculating means calculates a similarity degree between the template information for the control region, which template information has been stored in the pattern storing means, and the coloration state of the control region, which coloration state has been read out by the readout means, and

the judgment means detects an abnormal state of the test body solution in accordance with the similarity degree between the template information for the control region and the coloration state of the control region, which similarity degree has been calculated by the similarity degree calculating means.

Further, the analysis apparatus in accordance with the present invention may be modified such that the pattern storing means stores a plurality of pieces of the template information for the test region, each of which pieces is prepared with respect to one of different coloration degrees corresponding to different quantities of the analyte,

the similarity degree calculating means calculates the similarity degree between each of the plurality of the pieces of the template information for the test region and the coloration state of the test region, which coloration state has been read out by the readout means,

the judgment means detects a piece of the template information for the test region, which piece is associated with the highest similarity degree among the similarity degrees having been calculated with respect to the plurality of the pieces of the template information for the test region, and

the judgment means performs a quantitative analysis of the analyte in accordance with the thus detected piece of the template information for the test region.

With the analysis apparatus and the analysis method in accordance with the present invention, the coloration state of the test region is read out as the image density values by the readout means, and the calculation is made to find the similarity degree between the template information for the test region, which template information represents the state of coloration of the test region, and which has been stored previously in the pattern storing means, and the coloration state of the test region, which coloration state has been read out by the readout means. Also, the analysis of the analyte is performed in accordance with the similarity degree, which has been calculated. Therefore, even in cases where non-uniformity of the image density arises with the coloration state of the test region, the analysis of the analyte is performed accurately.

Also, the analysis apparatus in accordance with the present invention may be modified such that the test region is constituted of the predetermined pattern comprising the plurality of the basic pattern sections, each of which is constituted of the basic pattern, and the template information for the test region represents the state of coloration of the basic pattern constituting each of the basic pattern sections. In such cases, the similarity degree calculating means calculates the similarity degree by use of the plurality of the correlation values between the template information for the test region and the coloration state of the basic pattern, which coloration state has been read out by the readout means, the calculation of the correlation values being made by scanning the template information for the test region in the direction, in which the basic pattern sections are arrayed. With the modification described above, the calculation of the similarity degree is made efficiently and accurately.

Further, the analysis apparatus in accordance with the present invention may be modified such that the test piece is further provided with the control region, which is formed on the downstream side of the test region with respect to the direction of the development of the test body solution, and which has the predetermined shape, the control region undergoing coloration as a result of passage of the test body solution through the control region, and the readout means also reads out the coloration state of the control region as the image density values. In such cases, the pattern storing means also stores the template information for the control region, which template information represents the state of coloration of the control region. Also, the similarity degree calculating means calculates the similarity degree between the template information for the control region, which template information has been stored in the pattern storing means, and the coloration state of the control region, which coloration state has been read out by the readout means. Further, the judgment means detects the abnormal state of the test body solution in accordance with the similarity degree between the template information for the control region and the coloration state of the control region, which similarity degree has been calculated by the similarity degree calculating means. With the modification described above, the abnormal state of the analysis operation, such as an increase in viscosity of the test body solution or insufficiency of the quantity of the test body solution, is detected by use of the similarity degree.

Furthermore, the analysis apparatus in accordance with the present invention may be modified such that the basic pattern comprises the polygon or the circle, and the test region is constituted of the predetermined pattern comprising the plurality of the basic pattern sections, each of which is constituted of the basic pattern, the plurality of the basic pattern sections being arrayed so as to stand side by side in the direction perpendicularly intersecting with the direction of the development of the test body solution. The modification described above has the advantages over the cases, wherein a test region is formed in a strip-like shape as in the conventional technique, in that, in cases where non-uniformity occurs in a strip-like shape in a region other than the test region, the non-uniformity and the test region are easily distinguished from each other.

Further, the analysis apparatus in accordance with the present invention may be modified such that the pattern storing means stores the plurality of the pieces of the template information for the test region, each of which pieces is prepared with respect to one of the different coloration degrees corresponding to the different quantities of the analyte, and the similarity degree calculating means calculates the similarity degree between each of the plurality of the pieces of the template information for the test region and the coloration state of the test region, which coloration state has been read out by the readout means. In such cases, the judgment means detects the piece of the template information for the test region, which piece is associated with the highest similarity degree among the similarity degrees having been calculated with respect to the plurality of the pieces of the template information for the test region, and the judgment means performs the quantitative analysis of the analyte in accordance with the thus detected piece of the template information for the test region. With the modification described above, the quantitative analysis of the analyte is performed accurately.

### BRIEF DESCRIPTION OF THE DRAWINGS

FIG. 1 is a schematic front view showing a constitution of an embodiment of the analysis apparatus in accordance with the present invention,

FIG. 2 is an explanatory sectional side view showing an example of a test piece employed in the analysis apparatus in accordance with the present invention,

FIG. 3 is an explanatory sectional plan view showing the example of the test piece employed in the analysis apparatus in accordance with the present invention,

FIG. 4A is an explanatory plan view showing examples of a shape of a test region and a shape of a control region in a development layer,

FIG. 4B is an explanatory plan view showing different examples of the shape of the test region and the shape of the control region in the development layer,

FIG. 5 is a perspective view showing how the development layer of FIG. 4B is produced,

FIG. 6 is a block diagram showing an embodiment of the analysis apparatus in accordance with the present invention,

FIG. 7 is an explanatory view showing an example of template information having been stored in pattern storing means shown in FIG. 6,

FIG. 8 is a graph showing a distribution of pixel values along a cross-section taken on line VIII-VIII of FIG. 7,

FIG. 9 is an explanatory view showing a different example of the template information having been stored in the pattern storing means shown in FIG. 6, and

FIG. 10 is a flow chart showing an embodiment of the analysis method in accordance with the present invention.

### DESCRIPTION OF THE PREFERRED EMBODIMENTS

The present invention will hereinbelow be described in further detail with reference to the accompanying drawings.

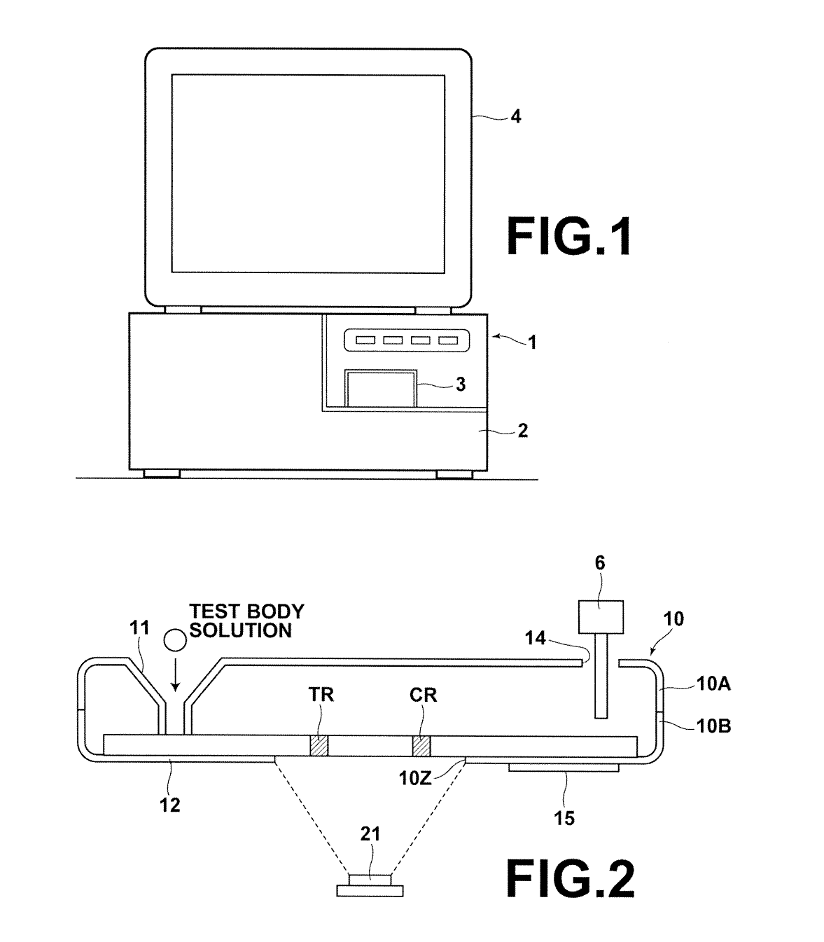

FIG. 1 is a schematic front view showing a constitution of an embodiment of the analysis apparatus in accordance with the present invention.

With reference to FIG. 1, an analysis apparatus 1, which is an embodiment of the analysis apparatus in accordance with the present invention, is constituted for performing readout of a coloration state from a test piece 10 for performing detection of an analyte by the utilization of, for example, the immunochromatographic technique. The analysis apparatus 1 comprises a case housing 2, a device insertion aperture 3, and information input and output means 4. The test piece 10, onto which a test body solution has been spotted, is inserted through the device insertion aperture 3. The coloration state arising as a result of a coloration reaction in the test piece 10 is read out optically. Also, the result of the readout is outputted to the information input and output means 4. The information input and output means 4 is an operation panel constituted of, for example, a liquid crystal touch panel. The user inputs basic setting information for the analysis via the operation panel.

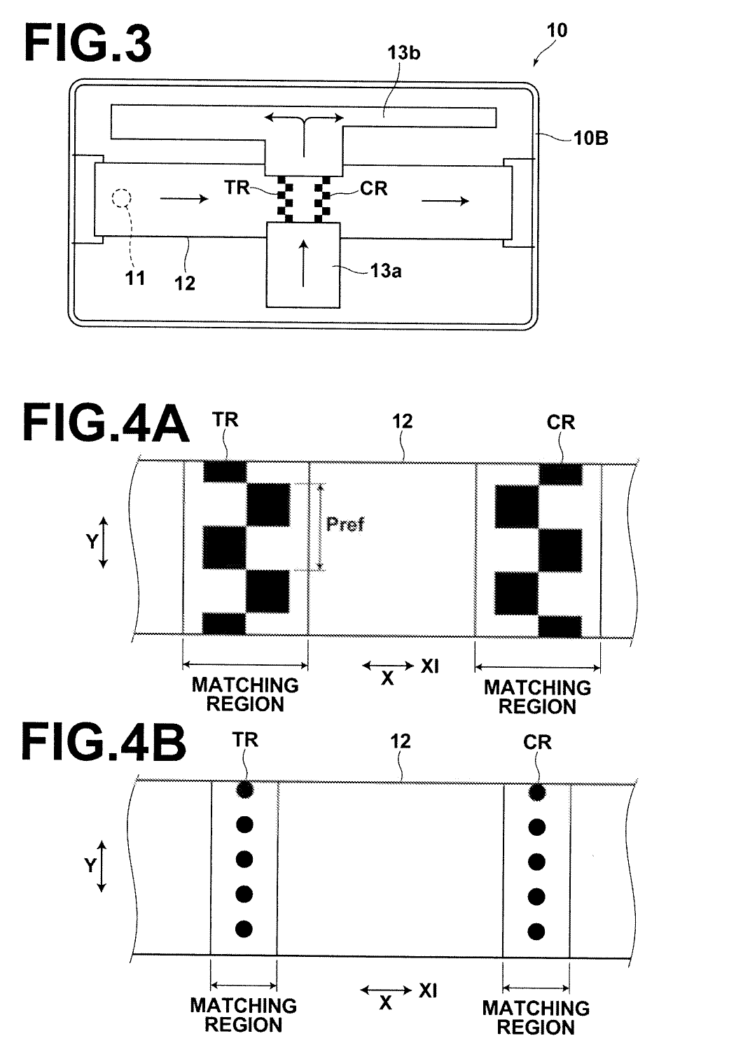

FIG. 2 is an explanatory sectional side view showing an example of the test piece 10, from which the coloration state is read out by the analysis apparatus 1. FIG. 3 is an explanatory sectional plan view showing the example of the test piece 10, from which the coloration state is read out by the analysis apparatus 1. As the test piece 10, it is possible to employ one of known techniques as described in, for example, Japanese Unexamined Patent Publication Nos. 2009-139256 and 2007-064766. Also, an example, wherein the test piece 10 enabling the so-called amplification processing is used, will be described hereinbelow. It is also possible to use a test piece in which the amplification processing is not performed.

As illustrated in FIG. 2, the test piece 10 is the device for performing a quantitative or qualitative (negative/positive) examination of an analyte by use of the immunochromatographic technique. In the test piece 10, the analyte (a predetermined antigen) is labeled such that the analyte becomes perceptible visually. A test body solution containing a mixture of a test body, which has the possibility of containing the analyte, and a labeling substance (a second antibody) is spotted onto the test piece 10.

The test piece 10 is provided with an upper casing 10A, a lower casing 10B, and a development layer 12. The development layer 12 is accommodated within the region surrounded by the upper casing 10A and the lower casing 10B. The upper casing 10A is provided with a through-hole 11, through which the test body solution is spotted from the exterior onto the development layer 12. The upper casing 10A is also provided with a through-hole 14, through which an amplifying liquid is spotted onto the development layer 12. The development layer 12 is secured to the inside bottom surface of the lower casing 10B. The lower casing 10B is provided with a viewing window 10Z for observation of the quantitative or qualitative analysis of the analyte. Also, an information storing means 15 is located on an outside bottom surface of the lower casing 10B. The information storing means 15 may be constituted of letter information, a bar code, an IC tag, or the like, for recording analyte identification information (the name of a patient, or the like), information representing the period of time required for the reaction, or the like.

The development layer 12 is constituted of an absorbing material, such as cellulose filter paper, glass fibers, or a polyurethane. The test body solution having been spotted onto the development layer 12 flows toward a predetermined direction by a capillary phenomenon through the development layer 12. The development layer 12 is provided with a test region TR and a control region CR. A first antibody, which has the specificity with respect to the analyte (the antigen), has been fixed to the test region TR. In cases where the analyte is present in the test body, a binding product of first antibody-analyte-second antibody is formed in the test region TR, and the test region TR undergoes coloration in a line-like shape. A reference antigen (or antibody), which reacts with the labeling antibody, has been fixed to the control region CR. The reference antigen reacts with labeling antibody contained in the test body solution, and the control region CR undergoes coloration in a line-like shape. Therefore, by confirming the coloration state of the control region CR, a judgment is made as to whether the test body solution has or has not passed through the test region TR and the control region CR.

Further, as illustrated in FIG. 3, the test piece 10 is provided with a washing layer 13a and a washing layer 13b. The washing layer 13a and the washing layer 13b are located so as to sandwich the test region TR and the control region CR from the opposite sides of the test region TR and the control region CR (i.e., from the opposite sides taken with respect to the direction approximately perpendicularly intersecting with the flow path of the test body solution). The washing layer 13a and the washing layer 13b form a flow path of a washing liquid for washing the test region TR and the control region CR. The washing layer 13a and the washing layer 13b are constituted of the material identical with the material of the development layer 12. The washing liquid is stored (not shown) on the side of the washing layer 13a. After the reaction in the test region TR and the reaction in the control region CR have been completed, the washing layer 13a is pushed from the analysis apparatus 1. As a result, the washing liquid flows by the capillary phenomenon from the washing layer 13a toward the side of the washing layer 13b. The washing liquid thus flows through the test region TR and the control region CR, which are located between the washing layer 13a and the washing layer 13b. In this manner, the labeling antibody, which did not take part in the formation of the immune complex in the test region TR and the immune complex in the control region CR, is removed.

Furthermore, as illustrated in FIG. 2, the upper casing 10A is provided with the through-hole 14 for developing the amplifying liquid, which contains the metal ion (such as silver colloid), from amplification processing means 6, which is located within the case housing 2 illustrated in FIG. 1, to the development layer 12. After the test region TR and the control region CR have been washed by the washing liquid, the amplifying liquid is developed through the development layer 12. As a result, the metal ion is bound to the immune complex in the test region TR and the immune complex in the control region CR, and the coloration state of the test region TR and the coloration state of the control region CR are thus amplified by the metal ion.

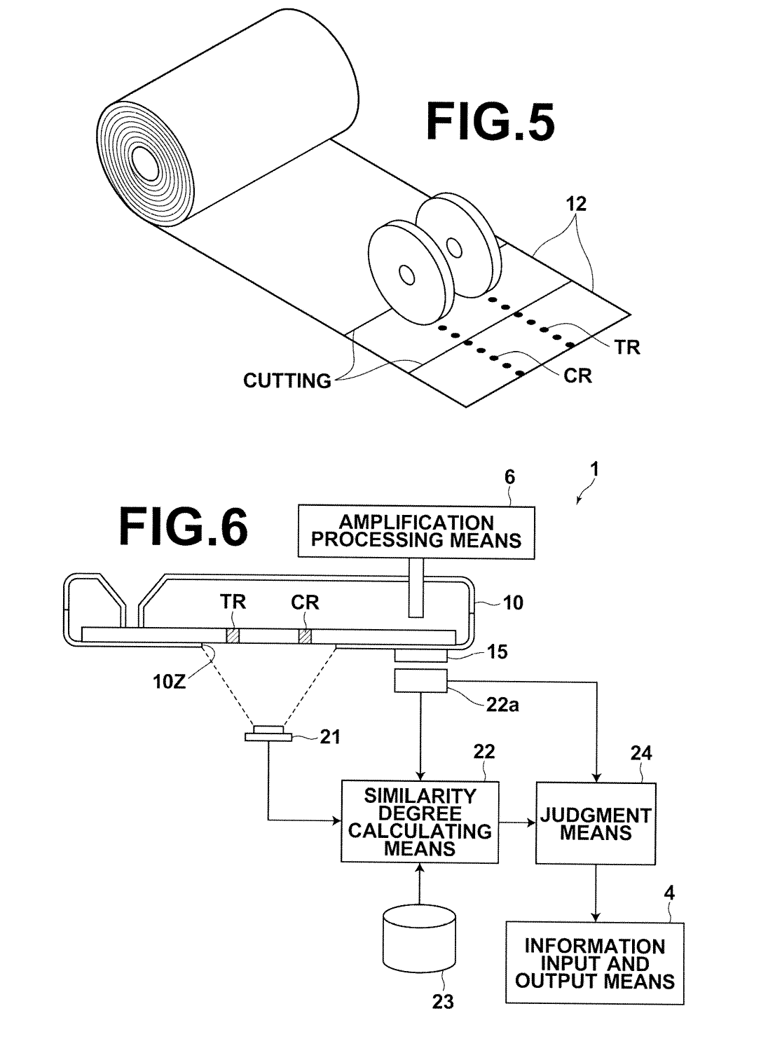

FIG. 4A is an explanatory plan view showing examples of a shape of a test region TR and a shape of a control region CR in a development layer 12. FIG. 4B is an explanatory plan view showing different examples of the shape of the test region TR and the shape of the control region CR in the development layer 12. In the examples shown in FIG. 4A, each of the test region TR and the control region CR is constituted of a predetermined non-linear pattern comprising a plurality of basic pattern sections, each of which is constituted of a predetermined basic pattern Pref. By way of example, each of the test region TR and the control region CR is constituted of the predetermined non-linear pattern comprising the plurality of the basic pattern sections, each of which is constituted of the predetermined basic pattern Pref comprising two quadrangles located diagonally, the plurality of the basic pattern sections being arrayed so as to stand side by side in the direction (indicated by the arrow Y) perpendicularly intersecting with the direction (indicated by the arrow X) of the development of the test body solution. Alternatively, as illustrated in FIG. 4B, the basic pattern Pref may be constituted of a circle, and the plurality of the basic pattern sections, each of which is constituted of the basic pattern Pref, may be arrayed so as to stand side by side along a straight line (in the direction indicated by the arrow Y) perpendicularly intersecting with the direction (indicated by the arrow X) of the development of the test body solution. In FIG. 4A, the basic pattern sections, each of which is constituted of the predetermined basic pattern Pref, are formed continuously. Also, in FIG. 4B, the basic pattern sections, each of which is constituted of the predetermined basic pattern Pref, are formed discretely. Alternatively, the basic pattern sections, each of which is constituted of the basic pattern Pref comprising the two quadrangles as shown in FIG. 4A, may be formed discretely. Also, the basic pattern sections, each of which is constituted of the predetermined basic pattern Pref comprising the circle as shown in FIG. 4B, may be formed continuously. As illustrated in FIG. 5, the development layer 12 provided with the test region TR and the control region CR may be produced by impregnating a continuous length roll of the absorbing material with the first antibody for the test region TR and the reference antigen (or antibody) for the control region CR in a line-like form, and cutting the continuous length roll of the absorbing material into sections having a required width.

FIG. 6 is a block diagram showing an embodiment of the analysis apparatus in accordance with the present invention. The analysis apparatus 1 shown in FIG. 6 comprises readout means 21, similarity degree calculating means 22, pattern storing means 23, and judgment means 24. The readout means 21 reads out the coloration state of the test region TR and the coloration state of the control region CR as the image density values through the viewing window 10Z. By way of example, the readout means 21 may be constituted of an image pickup device, such as a CCD or CMOS. The readout means 21 may read out the gray scale values as the image density values. Alternatively, the readout means 21 may read out R, G, and B component values as the image density values. As another alternative, the readout means 21 may read out the intensities of a predetermined color (a predetermined wavelength component) of the fluorescence, or the like, as the image density values. Further, the readout means 21 is not limited to the image pickup device and may be constituted of a light receiving device for receiving the reflected light or the fluorescence coming from the viewing window 10Z.

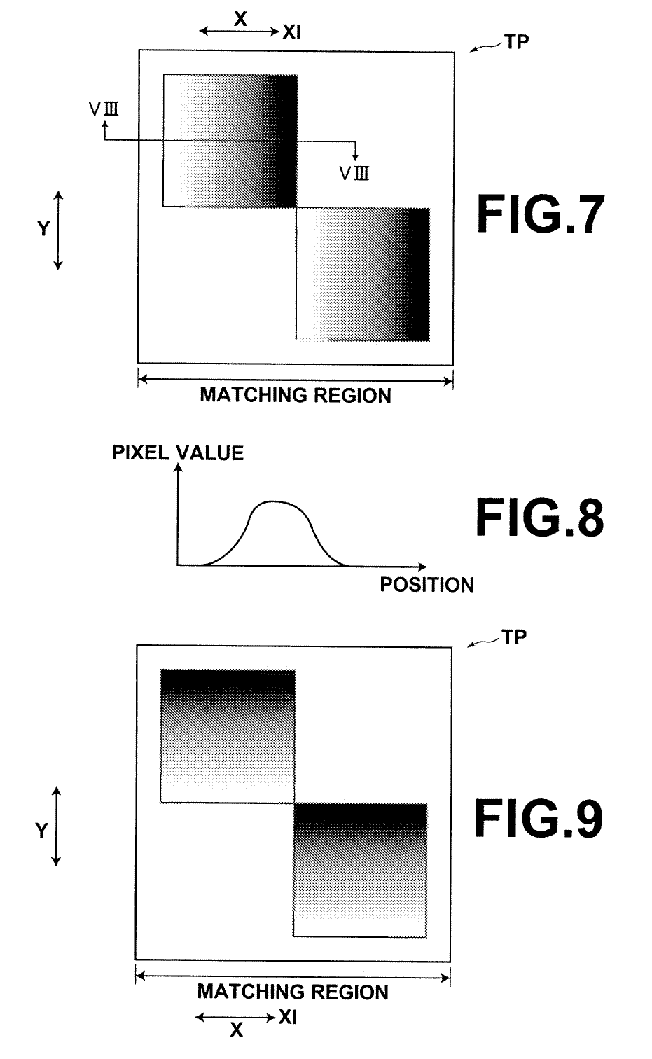

The similarity degree calculating means 22 calculates the similarity degree between template information TP, which has been stored in the pattern storing means 23, and the coloration state of the test region TR, which coloration state has been read out by the readout means 21. The pattern storing means 23 stores the template information TP as illustrated in FIG. 7. Particularly, the template information TP represents the shape identical with the shape of the basic pattern Pref of the test region TR and represents the image density values of the state of the coloration of the basic pattern Pref.

FIG. 8 is a graph showing a distribution of pixel values along a cross-section taken on line VIII-VIII of FIG. 7. For example, at the time at which the test body solution is developed through the development layer 12, the area of the test region TR, which area is located on the upstream side with respect to the direction of the development of the test body solution (i.e., with respect to the direction indicated by the arrow X1 in FIG. 4A), captures more of the analyte than the area of the test region TR, which area is located on the downstream side with respect to the direction of the development of the test body solution. Therefore, the area of the test region TR, which area is located on the upstream side with respect to the direction of the development of the test body solution, yields the image density values larger than the image density values of the area of the test region TR, which area is located on the downstream side with respect to the direction of the development of the test body solution. Also, as illustrated in FIG. 8, an edge area of the test region TR yields the image density values distributed so as to form a gentle envelope along the direction of the development of the test body solution. Specifically, the coloration state of the test region TR does not become uniform with respect to the direction of the development of the test body solution. The image density values of the test region TR thus have the image density distribution, such that the image density values become large from the area of the quadrangular domain constituting the basic pattern Pref of the test region TR, which area is located on the upstream side with respect to the direction of the development of the test body solution, toward the area of the quadrangular domain constituting the basic pattern Pref of the test region TR, which area is located on the downstream side with respect to the direction of the development of the test body solution. Accordingly, in the pattern storing means 23, the template information TP, which represents both the shape feature and the image density distribution, is prepared and stored.

The template information TP illustrated in FIG. 7 has the image density characteristics with respect to the direction of the development of the test body solution (i.e., the direction indicated by the arrow X). FIG. 9 is an explanatory view showing a different example of the template information having been stored in the pattern storing means shown in FIG. 6. Alternatively, as illustrated in FIG. 9, the template information TP may be prepared, which represents an image density distribution with respect to the direction of the development of the washing liquid (i.e., the direction indicated by the arrow Y). Specifically, in cases where the washing liquid flows from the washing layer 13a to the washing layer 13b in the washing step, the washing liquid located on the upstream side with respect to the direction of the development of the washing liquid has a larger washing effect than the washing liquid located on the downstream side with respect to the direction of the development of the washing liquid. Therefore, there is the risk that the labeling antibody, which is floating, will remain on the downstream side with respect to the direction of the development of the washing liquid. In cases where the amplification processing is performed in the state described above, non-uniformity in image density arises such that the image density values representing the coloration on the upstream side with respect to the direction of the development of the washing liquid become larger than the image density values representing the coloration on the downstream side with respect to the direction of the development of the washing liquid. Specifically, it often occurs that the coloration state of the test region TR does not become uniform with respect to the direction of the development of the washing liquid. Accordingly, the template information TP may be stored previously, which represents the predetermined image density characteristics with respect to the direction of the development of the washing liquid, i.e. with respect to different positions taken in the direction of the array of the basic pattern sections constituted of the basic pattern Pref.

The similarity degree calculating means 22 performs two-dimensional convolution by use of the image density values of the template information TP and the pixel values of the basic pattern Pref of the test region TR and thereby calculates the similarity degree (correlation value) between the template information TP and the coloration state of the test region TR, which coloration state has been read out by the readout means 21. Specifically, as illustrated in FIG. 4A or FIG. 4B, the similarity degree calculating means 22 sets the test region TR as a matching region. Also, the similarity degree calculating means 22 performs the calculation of the correlation value between the coloration state of the basic pattern Pref, which is located within the matching region, and the template information TP. The calculation of the correlation value is performed a plurality of times along the direction (indicated by the arrow Y), in which the basic patterns Pref, Pref, . . . are arrayed so as to stand side by side. Further, the similarity degree calculating means 22 calculates the total sum of the plurality of the correlation values as the similarity degree.

The judgment means 24 performs the quantitative or qualitative analysis of the analyte in accordance with the similarity degree, which has been calculated by the similarity degree calculating means 22. Specifically, the judgment means 24 stores information representing a set threshold value, which has been set previously, and performs the qualitative (positive/negative) judgment of the analyte by comparing the similarity degree and the set threshold value with each other.

As described above, the analysis is performed by considering both the shape features of test region TR and the image density characteristics of the coloration state of the test region TR by use of the template information TP. Therefore, the accuracy, with which the quantitative or qualitative analysis of the analyte is made, is enhanced. Also, the test region TR has the non-linear shape, which is formed by iterating the predetermined basic pattern Pref. Therefore, a strip-like pseudo-positive pattern occurring in the washing step is clearly discriminated from coloration state of the test region TR or the control region CR. Since each of the test region TR and the control region CR is formed by iterating the basic pattern Pref, the advantages are obtained over the conventional test pattern constituted of a single predetermined pattern in that the coloration state is discriminated easily.

Also, in the same manner as that for the test region TR, the similarity degree calculating means 22 calculates the similarity degree (the correlation value) with respect to the control region CR. Further, the judgment means 24 compares the similarity degree with a reference value, which has been set previously for the control region CR. In cases where it has been judged that the similarity degree is lower than the reference value, the judgment means 24 outputs a warning indicating that the viscosity of the test body solution is markedly high or that the quantity of the test body solution is markedly small.

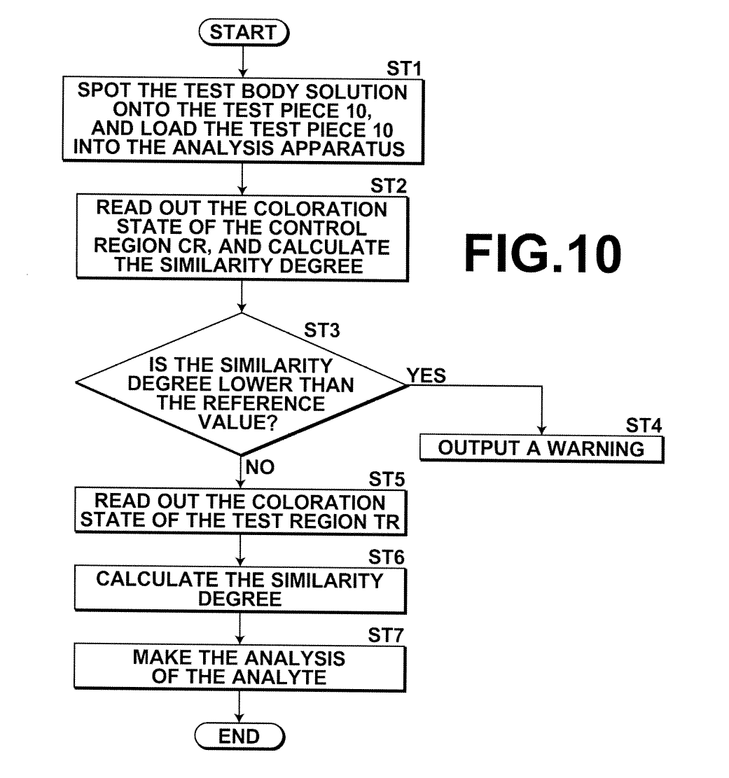

FIG. 10 is a flow chart showing an embodiment of the analysis method in accordance with the present invention. The embodiment of the analysis method in accordance with the present invention will be described hereinbelow with reference to FIG. 1 through FIG. 10. Firstly, in a step ST1, the test body solution is spotted onto the test piece 10, and the test piece 10 is loaded into the analysis apparatus 1. At this time, identification information readout means 22a illustrated in FIG. 6 reads out the information representing the kind of the examination antibody having been applied to the test piece 10, the information representing the analysis time, and the shape information of the test region TR and the control region CR from information storing means 15.

In a step ST2, at the time at which a predetermined period of time has passed after the test piece 10 has been loaded into the analysis apparatus 1, the coloration state of the control region CR is read out, and the calculation is made to find the similarity degree between the image density values of the control region CR and the template information TP for the control region CR. Also, in a step ST3, a judgment is made as to whether the similarity degree is or is not lower than the reference value. In cases where it has been judged that the similarity degree is lower than the reference value, a warning is outputted for indicating that the normal examination cannot be made due to a markedly high viscosity of the test body solution, an insufficient quantity of the test body solution, or the like.

In cases where it has been judged that the similarity degree is not lower than the reference value and that the coloration state of the control region CR is not in an abnormal state, the development of the test body solution (e.g., for 10 minutes), the washing processing and the amplification processing (e.g., for 5 minutes) are performed on the test piece 10. Also, in a step ST5, the coloration state of each of the test region TR and the control region CR after the amplification processing has been performed is read out as the image density values. Further, in a step ST6, the calculation is made to find the correlation value between the image density values of the test region TR and the template information TP for the test region TR. The correlation value is calculated as the similarity degree. Thereafter, in a step ST7, the judgment means 24 makes the quantitative or qualitative analysis of the analyte by use of the similarity degree and the set threshold value, and the information representing the result of the analysis is outputted from the information input and output means 4.

With the embodiment described above, the coloration state of the test region TR is read out by the readout means 21 as the image density values, and the calculation is made to find the similarity degree between the template information TP for the test region TR, which template information represents the state of coloration of the test region TR, and which has been stored previously in the pattern storing means 23, and the coloration state of the test region TR, which coloration state has been read out by the readout means 21. Also, the analysis of the analyte is performed in accordance with the similarity degree, which has been calculated. Therefore, the analysis of the analyte is performed accurately in accordance with the coloration state of the test region.

Also, with the embodiment described above, the test region TR is constituted of the predetermined pattern comprising the plurality of the basic pattern sections, each of which is constituted of the basic pattern Pref, and the template information TP for the test region TR represents the state of coloration of the basic pattern Pref constituting each of the basic pattern sections. In such cases, the similarity degree calculating means 22 calculates the similarity degree by use of the plurality of the correlation values between the template information TP for the test region TR and the coloration state of the basic pattern Pref, which coloration state has been read out by the readout means 21, the calculation of the correlation values being made by scanning the template information TP for the test region TR in the direction, in which the basic pattern sections are arrayed. With the constitution described above, the calculation of the similarity degree is made efficiently and accurately.

Further, with the embodiment described above, the test piece 10 is further provided with the control region CR, which is formed on the downstream side of the test region TR with respect to the direction of the development of the test body solution, and which has the predetermined shape, the control region CR undergoing coloration as a result of passage of the test body solution through the control region CR, and the readout means 21 also reads out the coloration state of the control region CR as the image density values. In such cases, the pattern storing means 23 also stores the template information TP for the control region CR, which template information represents the state of coloration of the control region CR. Also, the similarity degree calculating means 22 calculates the similarity degree between the template information TP for the control region CR, which template information has been stored in the pattern storing means 23, and the coloration state of the control region CR, which coloration state has been read out by the readout means 21. Further, the judgment means 24 detects the abnormal state of the test body solution in accordance with the similarity degree between the template information TP for the control region CR and the coloration state of the control region CR, which similarity degree has been calculated by the similarity degree calculating means 22. With the constitution described above, the abnormal state of the analysis operation, such as an increase in viscosity of the test body solution or insufficiency of the quantity of the test body solution, is detected by use of the similarity degree.

Furthermore, with the embodiment described above, the basic pattern Pref comprises the polygon or the circle, and the test region TR is constituted of the predetermined pattern comprising the plurality of the basic pattern sections, each of which is constituted of the basic pattern Pref, the plurality of the basic pattern sections being arrayed so as to stand side by side in the direction perpendicularly intersecting with the direction of the development of the test body solution. The constitution described above has the advantages over the cases, wherein a test region is formed in a strip-like shape as in the conventional technique, in that the washing non-uniformity and the test region TR are easily distinguished from each other.

Further, the embodiment described above may be modified such that the pattern storing means 23 stores the plurality of the pieces of the template information TP, TP, . . . for the test region TR, each of which pieces is prepared with respect to one of the different coloration degrees corresponding to the different quantities of the analyte, and the similarity degree calculating means 22 calculates the similarity degree between each of the plurality of the pieces of the template information TP, TP, . . . for the test region TR and the coloration state of the test region TR, which coloration state has been read out by the readout means 21. In such cases, the judgment means 24 detects the piece of the template information TP for the test region TR, which piece is associated with the highest similarity degree among the similarity degrees having been calculated with respect to the plurality of the pieces of the template information TP, TP, . . . for the test region TR, and the judgment means 24 performs the quantitative analysis of the analyte in accordance with the thus detected piece of the template information TP for the test region TR. With the modification described above, the quantitative analysis of the analyte is performed accurately.

The analysis apparatus in accordance with the present invention is not limited to the embodiment described above and may be embodied in various other ways. For example, in FIG. 4A, the basic pattern Pref is constituted of the quadrangles. Also, in FIG. 4B, the basic pattern Pref is constituted of the circle. Alternatively, the basic pattern Pref may be constituted of a polygon, such as a triangle, a pentagon, or a parallelogram. Also, in the example illustrated in FIG. 4A or FIG. 4B, the test region TR and the control region CR has an identical pattern. Alternatively, the test region TR and the control region CR may be formed by different patterns. Further, the development layer 12 may be provided with a plurality of the test regions TR, TR, . . . .

Further, in the embodiment described above, the template information TP is prepared in accordance with the basic pattern Pref. Alternatively, the pattern of the entire area of the test region TR may be prepared as the template information TP.

Furthermore, the pattern storing means 23 may store the plurality of the pieces of the template information TP, TP, . . . for the test region TR, each of which pieces is prepared with respect to one of the different coloration degrees corresponding to the different quantities of the analyte. In such cases, the similarity degree calculating means 22 calculates the similarity degree between each of the plurality of the pieces of the template information TP, TP, . . . for the test region TR, which pieces correspond to the different coloration degrees, and the coloration state of the test region TR, which coloration state has been read out by the readout means 21. Also, the judgment means 24 detects the piece of the template information TP for the test region TR, which piece is associated with the highest similarity degree among the similarity degrees having been calculated with respect to the plurality of the pieces of the template information TP, TP, . . . for the test region TR, and the judgment means 24 makes the quantitative judgment of the analyte in accordance with the thus detected piece of the template information TP for the test region TR.

What is claimed is:

1. An analysis apparatus for performing an analysis of an analyte by use of a test piece provided with a development layer, through which a test body solution is developed, and a test region, which is formed on the development layer, and which has a predetermined shape, the test region reacting with an analyte contained in the test body solution and undergoing coloration as a result of the reaction, the apparatus comprising:
i) readout means for reading out the coloration state of the test region as image density values,
ii) pattern storing means for storing template information for the test region, which template information represents a state of coloration of the test region,
iii) similarity degree calculating means for calculating a similarity degree between the template information for the test region, which template information has been stored in the pattern storing means, and the coloration state of the test region, which coloration state has been read out by the readout means, and
iv) judgment means for performing the analysis of the analyte in accordance with the similarity degree, which has been calculated by the similarity degree calculating means.

2. An analysis apparatus as defined in claim 1 wherein the similarity degree calculating means calculates a correlation value, which is obtained by performing convolution on the template information for the test region and the image density values of the test region, which image density values have been read out by the readout means, and
the thus calculated correlation value is taken as the similarity degree.

3. An analysis apparatus as defined in claim 1 wherein the judgment means stores information representing a set threshold value, which has been set previously, and performs a quantitative or qualitative judgment of the analyte by comparing the similarity degree and the set threshold value with each other.

4. An analysis apparatus as defined in claim 1 wherein the test region is constituted of a predetermined pattern comprising a plurality of basic pattern sections, each of which is constituted of a basic pattern,
the template information for the test region represents the state of coloration of the basic pattern constituting each of the basic pattern sections,
the similarity degree calculating means calculates a correlation value between the template information for the test region and the coloration state of the basic pattern, which coloration state has been read out by the readout means, the calculation of the correlation value being made with respect to each of the basic pattern sections, and
the similarity degree calculating means calculates the similarity degree in accordance with the result of the calculation of the correlation value between the template information for the test region and the coloration state of the basic pattern, which coloration state has been read out by the readout means.

5. An analysis apparatus as defined in claim 4 wherein the basic pattern comprises a polygon or a circle, and
the test region is constituted of the predetermined pattern comprising the plurality of the basic pattern sections, each of which is constituted of the basic pattern, the plurality of the basic pattern sections being arrayed so as to stand side by side in a direction perpendicularly intersecting with the direction of the development of the test body solution.

6. An analysis apparatus as defined in claim 1 wherein the test piece is further provided with a control region, which is formed on a downstream side of the test region with respect to the direction of the development of the test body solution, and which has a predetermined shape, the control region undergoing coloration as a result of passage of the test body solution through the control region,
the readout means also reads out the coloration state of the control region as the image density values,
the pattern storing means also stores template information for the control region, which template information represents a state of coloration of the control region,
the similarity degree calculating means calculates a similarity degree between the template information for the control region, which template information has been stored in the pattern storing means, and the coloration state of the control region, which coloration state has been read out by the readout means, and
the judgment means detects an abnormal state of the test body solution in accordance with the similarity degree between the template information for the control region and the coloration state of the control region, which similarity degree has been calculated by the similarity degree calculating means.

7. An analysis apparatus as defined in claim 1 wherein the pattern storing means stores a plurality of pieces of the template information for the test region, each of which pieces is prepared with respect to one of different coloration degrees corresponding to different quantities of the analyte,
the similarity degree calculating means calculates the similarity degree between each of the plurality of the pieces of the template information for the test region and the coloration state of the test region, which coloration state has been read out by the readout means,
the judgment means detects a piece of the template information for the test region, which piece is associated with the highest similarity degree among the similarity degrees having been calculated with respect to the plurality of the pieces of the template information for the test region, and
the judgment means performs a quantitative analysis of the analyte in accordance with the thus detected piece of the template information for the test region.

8. An analysis method for performing an analysis of an analyte by use of a test piece provided with a development layer, through which a test body solution is developed, and a test region, which is formed on the development layer, and which has a predetermined shape, the test region reacting with an analyte contained in the test body solution and undergoing coloration as a result of the reaction, the method comprising the steps of:
i) reading out the coloration state of the test region as image density values by readout means,
ii) calculating a similarity degree between template information for the test region, which template information represents a state of coloration of the test region, and which has been stored previously in pattern storing means, and the coloration state of the test region, which coloration state has been read out by the readout means, and
iii) performing the analysis of the analyte in accordance with the similarity degree, which has been calculated.
